(19) United States
(12) Patent Application Publication
(10) Pub. No.: US 2023/0169486 A1
(43) Pub. Date: Jun. 1, 2023

(54) SYSTEM AND METHOD FOR THE AUTOMATED PROVISION OF TRANSACTIONAL DATA

(71) Applicant: Chargezoom, Inc., Irvine, CA (US)

(72) Inventor: Matthew Dubois, Irvine, CA (US)

(73) Assignee: Chargezoom, Inc., Irvine, CA (US)

(21) Appl. No.: 17/587,494

(22) Filed: Jan. 28, 2022

Related U.S. Application Data
(60) Provisional application No. 63/285,063, filed on Dec. 1, 2021.

(51) Int. Cl. G06Q 20/24; G06Q 40/02; G06Q 20/40; G06Q 20/02

(52) U.S. Cl. CPC G06Q 20/24; G06Q 20/027; G06Q 20/4016; G06Q 40/025

(57) ABSTRACT

In various embodiments, a computer-implemented method for the automatic provision of transactional data can include: by a computer system, accessing a credit transaction including an initial transaction profile and an initial risk profile; by the computer system, accessing an external server including an external data set associated with the credit transaction; by the computer system, augmenting the initial transaction profile with the external data set to generate a secondary transaction profile and a secondary risk profile; by the computer system, transmitting the secondary transaction profile to a credit server associated with a credit provider; and by the computer system, receiving a confirmation from the credit server of the secondary transaction profile associated with the credit transaction. In additional embodiments, the external data set can include publicly available data and the secondary transaction profile can include level three transaction data.

### CROSS-REFERENCE TO RELATED APPLICATIONS

The present application claims priority to U.S. Provisional Pat. Application serial number 63/285,063, filed on Dec. 01, 2021, and entitled “System and Method for Omnidirectional Syncing of Payment Data,” the contents of which are incorporated herein for all purposes by this reference.

### FIELD

The present invention relates to the field of cashless payment technologies and, more particularly, to a system and method for the automated provision of transactional data in cashless payment systems.

### BACKGROUND

An increasing number of businesses and consumers are utilizing credit based and/or financed payments for goods and services. In credit card transactions, a set of entities control a network through which banks (both acquiring and issuing) conduct credit-based transactions. As compensation for use of the network, the set of entities charge an interchange rate that is typically determined as a function of the risk associated with the transaction. Generally, transactions that are characterized by more data are considered lower risk, and therefore the usage fees associated with the network are lower.

Generally, the risk of loss due to fraud or chargeback is borne by the acquiring bank, which selects the merchants and assesses the risk accordingly. For example, an acquiring bank can examine a merchant’s credit score and determine a rate to charge the merchant (typically the interchange rate plus a risk premium). Thus, only a portion of the fees charged to the merchant are for use of the network (e.g., the interchange rate), with the remainder including profit and/or risk offset to the acquiring bank.

The interchange rate can vary depending upon the level of data supplied to the network in order to minimize potential risks to its users, including merchants, issuing banks, and acquiring banks. However, typical data gathering systems are engineered for ease and simplicity and to ensure capture of the sale, therefore all but eliminating the ability for users to acquire the necessary data to lower the interchange rate. For example, a typical credit card transaction may ask for a purchaser name, merchant name, purchase amount, and billing zip code, which is a relatively low level of data and therefore results in a higher interchange rate on the network. Moreover, existing data capture systems cannot automatically gather, normalize, format, store and transmit the necessary data to the entities associated with the network. Rather, existing data capture systems rely entirely upon distributed, asynchronous, and tedious data gathering, data cleaning, and data entry, the costs of which do not offset any gains to be received through a lower interchange rate.

Accordingly, there is a need in the art for improved technologies and methods to enable automated gathering, normalizing, formatting, storage, and transmission of transaction related data.

### SUMMARY

Certain embodiments of the present invention can provide solutions to the technical problems and needs in the art that have not yet been fully identified, appreciated, or solved by current credit-based payment network technologies.

In one embodiment, a computer-implemented method for the automatic provision of transactional data can include: by a computer system, accessing a credit transaction including an initial transaction profile and an initial risk profile; by the computer system, accessing an external server including an external data set associated with the credit transaction; by the computer system, augmenting the initial transaction profile with the external data set to generate a secondary transaction profile and a secondary risk profile; by the computer system, transmitting the secondary transaction profile to a credit server associated with a credit provider; and by the computer system, receiving a confirmation from the credit server of the secondary transaction profile associated with the credit transaction.

In another embodiment, the method can include by the computer system, accessing a second external server including a second external data set associated with the credit transaction, wherein the second external server includes a database including publicly available data.

In another embodiment of the method, the initial transaction profile includes an initial purchaser dataset and an initial merchant dataset; and the initial risk profile is computed in response to the initial transaction profile.

In another embodiment, the method can include by the computer system, importing an element from the external data set; by the computer system, formatting the element into a compatible format; by the computer system, automatically entering the formatted element into one of the initial purchaser dataset or the initial merchant dataset.

In another embodiment of the method, the formatted element includes level three transactional data.

In yet another embodiment of the method, the secondary risk profile is computed in response to the secondary transaction profile.

In still another embodiment of the method, receiving a confirmation from the credit server of the secondary transaction profile associated with the credit transaction includes: receiving, from the credit server, a discounted interchange rate associated with the credit transaction.

Another embodiment can include a computer system for the automatic provision of transactional data including: at least one processor; and memory including a set of instructions for the automatic provision of transactional data, wherein the set of instructions, with the at least one processor, is configured to cause the computer system to: access a credit transaction including an initial transaction profile and an initial risk profile; access an external server including an external data set associated with the credit transaction; augment the initial transaction profile with the external data set to generate a secondary transaction profile and a secondary risk profile; transmit the secondary transaction profile to a credit server associated with a credit provider; and receive a confirmation from the credit server of the secondary transaction profile associated with the credit transaction.

In another embodiment, the set of instructions, together with the at least one processor, are further configured to: access a second external server including a second external data set associated with the credit transaction, wherein the second external server includes a database including publicly available data.

In another embodiment of the computer system, the initial transaction profile includes an initial purchaser dataset and an initial merchant dataset; and the initial risk profile is computed in response to the initial transaction profile.

In another embodiment the set of instructions and at least one processor are further configured to: import an element from the external data set; format the element into a compatible format; and automatically enter the formatted element into one of the initial purchaser dataset or the initial merchant dataset.

In another embodiment of the computer system, the formatted element comprises level three transactional data.

In yet another embodiment of the computer system, the secondary transaction profile is computed in response to the secondary transaction profile.

In still another embodiment of the computer system, the set of instructions and at least one processor are configured to: receive, from the credit server, a discounted interchange rate associated with the credit transaction.

Another embodiment includes a computer program embodied on a non-transitory computer readable medium, wherein the computer program when executed is configured to cause at least one processor to: access a credit transaction including an initial transaction profile and an initial risk profile; access an external server including an external data set associated with the credit transaction; augment the initial transaction profile with the external data set to generate a secondary transaction profile and a secondary risk profile; transmit the secondary transaction profile to a credit server associated with a credit provider; and receive a confirmation from the credit server of the secondary transaction profile associated with the credit transaction.

In another embodiment, the computer program product is further configured to cause at least one processor to: access a second external server including a second external data set associated with the credit transaction, wherein the second external server includes a database including publicly available data.

In another embodiment of the computer program product, the initial transaction profile includes an initial purchaser dataset and an initial merchant dataset; and the initial risk profile is computed in response to the initial transaction profile.

In another embodiment, the computer program product is further configured to cause the at least one processor to: import an element from the external data set; format the element into a compatible format; automatically enter the formatted element into one of the initial purchaser dataset or the initial merchant dataset.

In another embodiment of the computer program product, the formatted element includes level three transactional data; and the secondary risk profile is computed in response to the secondary transaction profile.

In another embodiment, the computer program product is further configured to cause at least one processor to receive, from the credit server, a discounted interchange rate associated with the credit transaction.

These and other embodiments, and variations and alternatives thereof, are described below in detail with reference to the following figures.

### BRIEF DESCRIPTION OF THE FIGURES

In order that the advantages of certain embodiments of the invention will be readily understood, a more particular description of the invention briefly described above will be rendered by reference to specific embodiments that are illustrated in the appended figures. While it should be understood that these figures depict only typical embodiments of the invention and are not therefore to be considered to be limiting of its claimed scope, the invention will be described and explained with additional specificity and detail through the use of the accompanying claimed, in which:

FIG. 1 is a schematic diagram of an operating environment of a computer system in accordance with one embodiment of the present invention;

FIG. 2 is a schematic block diagram of an exemplary computer system in accordance with another embodiment of the present invention;

FIG. 3 is a schematic block diagram of an operating environment of a computer system in accordance with another embodiment of the present invention; and

FIG. 4 is a flow chart of a method in accordance with another embodiment of the present invention.

### DETAILED DESCRIPTION OF THE EMBODIMENTS

### 1. Overview

Generally, various embodiments of the computer system 100 are configured to: automatically retrieve, access, and acquire level three transaction data from a variety of databases; automatically format and translate disparate data streams into a uniform transaction data reporting format; and automatically submit full sets of level three transaction data to servers or systems associated with credit-granting entities to minimize the amount of assessed risk associated with a credit-based transaction.

In some embodiments, the computer system 100 is in communication with a payment processing entity (e.g., a payment gateway) and one or more servers associated with the credit-granting entity. The computer system 100 can therefore function as an intermediary service that interfaces between the credit server and the payment gateway. In other embodiments, the computer system 100 can be integrated into the payment gateway. In other embodiments, the computer system 100 can be integrated into the credit server. In still other embodiments, the computer system 100 can be configured as a cloud-based technological solution that is accessible to and/or interfaces with multiple payment gateways and multiple credit servers to provide seamless and complete transaction data to the credit-granting entities and thus relieve some financing burden on the payment processing entities.

### 2. Benefits

As described in detail below, the computer system 100 can be configured to retrieve, standardize, normalize, populate, and/or reconcile transactional data sets relating to credit-based transactions to generate full-scope level three transactional data and lessen the perceived risk in financed transactions. In doing so, the computer system 100 can relieve payment processing entities and/or merchants from having to inefficiently retrieve and/or enter certain transaction data using existing technologies. Moreover, the computer system 100 can lessen the processing time for level three transactions by automatically accessing the appropriate transaction data, formatting the transaction data, and transmitting the transaction data to one or more of the payment gateway or the credit server.

One benefit of the various embodiments of the computer system 100 is that the computer system 100 provides seamless and automated acquisition, presentation, and transmission of level three transaction data to both payment processing entities and credit-granting entities. In operation, the computer system 100 can be configured to access, present, and transmit uniform level three transaction data to interested entities. In other embodiments, the computer system 100 can be configured to access, present, and transmit custom level three transaction data to distinct entities, depending upon the type of transaction data requested and/or required by such entities. Generally, level three transaction data can include some or all of the following data: merchant name, transaction amount, date, merchant zip code, merchant tax identification number, discount amount, shipping amount, duty amount, item commodity code, item descriptor, product code, quantity, unit of measure, unit of cost, discount per line item, ship-to zip code, ship-from zip code, destination country, VAT information, tax amount, tax indicator, customer code, debit or credit indicator, SKU, split shipments, corporate status, small business status, supplier reference code, and/or supplier reference number. In accessing these data, the computer system 100 can interface with and/or access one or more databases relating to the merchant and/or the purchaser, as well as publicly available databases that include publicly available information relating to the transaction (e.g., a tax type/amount for a ship-to or ship-from zip code).

Advantageously, various embodiments of the computer system 100 can access, ingest, translate, and format these disparate data sets into uniformly presented data fields for the transmission and acceptance of level three transaction data. For example, zip (postal) code data can be provided in numerous formats within the United States (five-digit code, five-digit code plus four, etc.), and even more formats outside the United States. As described in detail below, embodiments of the computer system 100 can automatically translate and format ship-from zip code data and ship-to zip code data into standardized formats for receipt and acknowledgement of the level three transaction data.

Additional benefits of the various embodiments of the computer system 100 include greatly increased transparency between electronic transaction platforms, real-time or near real-time acquisition and exchange of level three transaction data across electronic transaction platforms, and increased efficiency and integration with existing financial software and customer relations management technologies.

### 3. Computer System Architecture

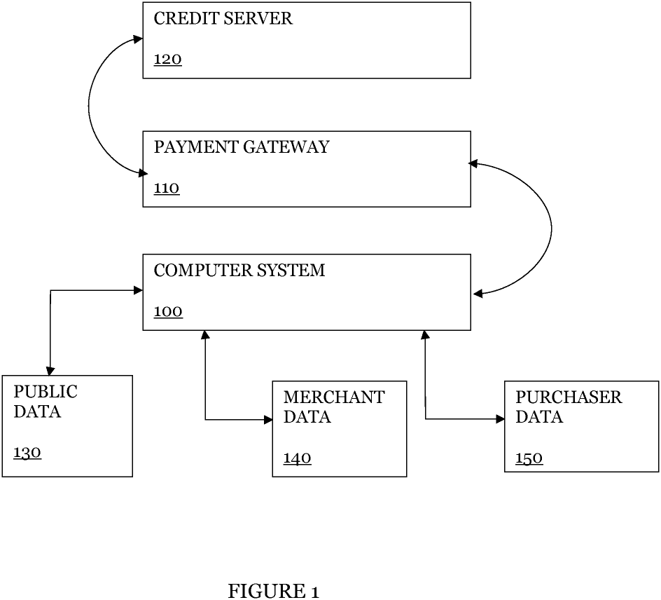

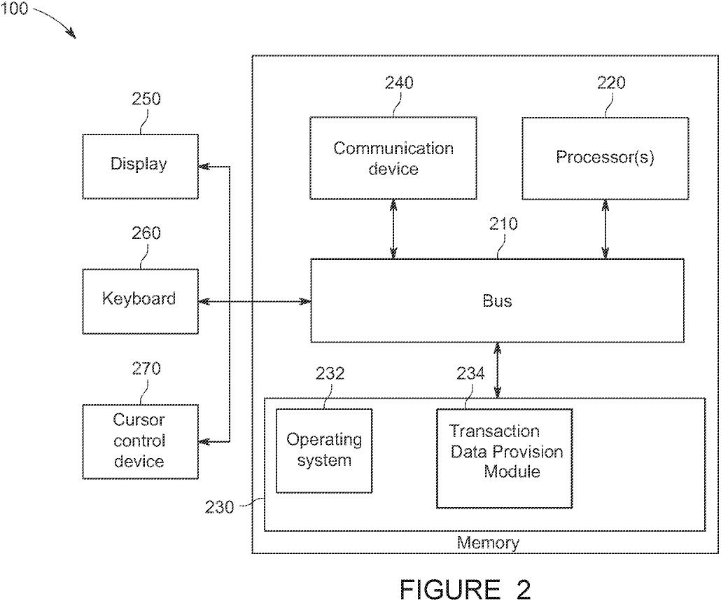

Generally, the methods and techniques described herein are performed by a computer system 100, as shown in FIGS. 1 and 2. For example, FIG. 2 is an exemplary architectural diagram illustrating a computer system 100 configured to automatically reconcile and synchronize distinct data sets in an end-to-end manner between a credit card service provider associated with a credit server 120 and a payment gateway 110 associated with a merchant or vendor. In some embodiments, the computer system 100 is configured as a cloud based platform or service that can access other software applications, services, servers, datasets, and/or databases associated with the user-merchant, purchaser-payor, credit card network, one or more payment gateways, one or more payment providers, and one or more public/private data sets, etcetera.

In some embodiments, the computer system 100 can be one or more of the computing systems depicted and/or described herein. The computer system 100 can include a bus 210 or other communication mechanism for communicating information, and one or more processor(s) 220 coupled to the bus 210 for processing information. The processor(s) 220 can be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. The processor(s) 220 can also have multiple processing cores, and at least some of the cores can be configured to perform specific functions. Multi-parallel processing can be used in some embodiments. In certain embodiments, at least one of the processor(s) 220 can be a neuromorphic circuit that includes processing elements that mimic biological neurons. In some embodiments, neuromorphic circuits might not require the typical components of a Von Neumann computing architecture.

The computer system 100 can also include a memory 230 for storing information and instructions to be executed by the processor(s) 220. The memory 230 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media can be any available media that can be accessed by the processor(s) 220 and can include volatile media, non-volatile media, or both. The media can also be removable, non-removable, or both.

Additionally, the computer system 100 can include a communication device 240, such as a transceiver, to provide access to a communications network via a wireless and/or wired connection. In some embodiments, the communication device 240 can be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the claimed invention. In some embodiments, the communication device 240 can include one or more antennas that are singular, arrayed, phased, switched, beamforming, beamsteering, a combination thereof, and or any other antenna configuration without deviating from the scope of the claimed invention.

The processor(s) 220 are further coupled via the bus 210 to a display 250, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina^{®} display, an In-Plane Switching (IPS) display, or any other suitable display for displaying information to a user. The display 250 can be configured as a touch (haptic) display, a three dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etcetera. Any suitable display device and haptic I/O can be used without deviating from the scope of the claimed invention.

A keyboard 260 and a cursor control device 270, such as a computer mouse, a touchpad, etc., are further coupled to the bus 210 to enable a user to interface with the computer system 100. However, in certain embodiments, a physical keyboard and mouse might not be present, and the user can interact with the computer system 100 solely through display 250 and/or a touchpad (not shown). Any type and combination of input devices can be used as a matter of design choice. In certain embodiments, no physical input device and/or display is present. For instance, the computer system 100 can be configured as a cloud-based or remote server-based system, in which case the user can interact with computer system 100 remotely via another system (not shown) in communication therewith. In still other embodiments, the computer system 100 can operate autonomously, semi-autonomously, or by implementing machine learning techniques.

The memory 230 stores software modules that provide functionality when executed by the processor(s) 220. The modules can include an operating system 232 for computer system 100. The modules can further include a transaction data provision module 234 that is configured to perform all or part of the processes, techniques, or methods described herein or derivatives thereof. The computer system 100 can include one or more additional modules that include additional functionality.

One skilled in the art will appreciate that a “computer system” could be embodied as a server, an embedded computing system, a personal computer, a console, a personal digital assistant (PDA), a cell phone, a tablet computing device, a quantum computing system, or any other suitable computing device, or combination of devices without deviating from the scope of the claimed invention. Presenting the above-described functions as being performed by a “computer system” is not intended to limit the scope of the claimed invention in any way, but is intended to provide one example of the many embodiments of the claimed invention. Indeed, methods, systems, and apparatuses disclosed herein can be implemented in localized and distributed forms consistent with computing technology, including cloud computing systems.

It should be noted that some of the computer system 100 features described in this specification have been presented as modules, in order to emphasize their implementation independence more particularly. For example, a module can be implemented as a hardware circuit comprising custom very large scale integration (VLSI) circuits or gate arrays, off-the-shelf semiconductors such as logic chips, transistors, or other discrete components. A module can also be implemented in programmable hardware devices such as field programmable gate arrays, programmable array logic, programmable logic devices, graphics processing units, or the like.

A module can also be at least partially implemented in software for execution by various types of processors. An identified unit of executable code can, for instance, include one or more physical or logical blocks of computer instructions that can, for instance, be organized as an object, procedure, or function. Nevertheless, the executables of an identified module need not be physically located together, but can include disparate instructions stored in different locations that, when joined logically together, comprise the module and achieve the stated purpose for the module. Further, modules can be stored on a computer-readable medium, which can be, for instance, a hard disk drive, flash device, RAM, tape, and/or any other such non-transitory computer-readable medium used to store data without deviating from the scope of the invention.

Indeed, a module of executable code could be a single instruction, or many instructions, and can even be distributed over several different code segments, among different programs, and across several memory devices. Similarly, operational data can be identified and illustrated herein within modules, and can be embodied in any suitable form and organized within any suitable type of data structure. The operational data can be collected as a single data set, or can be distributed over different locations including over different storage devices, and can exist, at least partially, merely as electronic signals on a system or network.

The process steps performed in by the system 100 can be performed by a computer program, encoding instructions for the processor(s) to perform at least part of the process(es), techniques, or methods described herein, in accordance with embodiments of the claimed invention. The computer program can be embodied on a non-transitory computer-readable medium. The computer-readable medium can be, but is not limited to, a hard disk drive, a flash device, RAM, a tape, and/or any other such medium or combination of media used to store data. The computer program can include encoded instructions for controlling the processor(s) of a computer system (e.g., the processor(s) 220 of the computer system 100 of FIG. 2) to implement all or part of the process steps described in herein, which can also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, an ASIC, or any other suitable device.

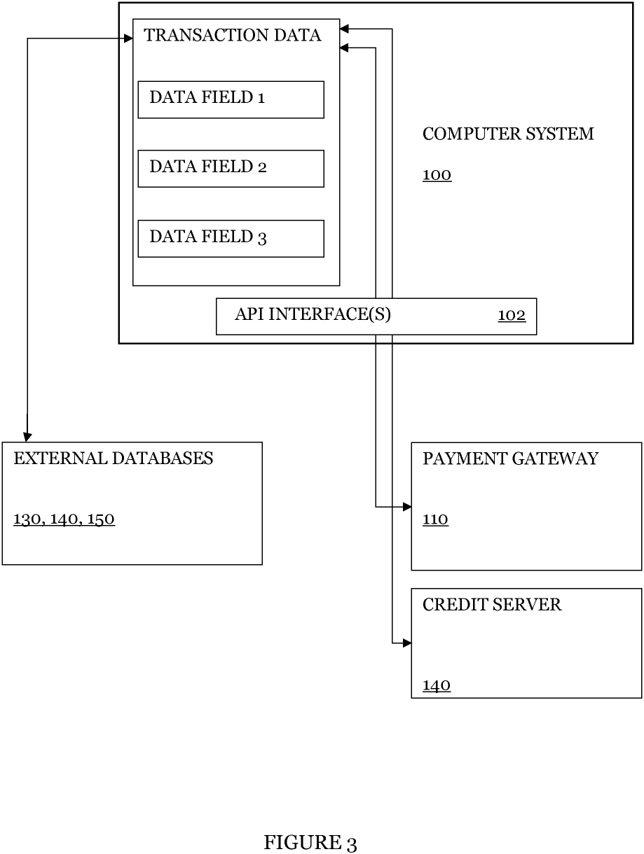

As shown in FIGS. 1 and 3, in one embodiment the computer system 100 can be connected, for example through one or more application programming interfaces (APIs) 102, to a payment gateway 110, a credit server 120 associated with a credit transaction (e.g., a credit card transaction), and one or more external databases including for example a public database 130, a merchant database 140, and a purchaser database 150. As described in detail below, in some embodiments two or more of the external databases 130, 140, 150 can be assembled, combined, and/or managed as a single database and integrated with the computer system 100. In some embodiments, the merchant database 140 and/or the purchaser database 150 can be associated with and/or resident within a merchant accounting system, enterprise resource planning (ERP) platform, and/or a customer relations management (CRM) platform. In some embodiments, the merchant database 140 and/or purchaser database 150 can be integral with or associated with cloud-based software-as-a-service (SaaS) computing platforms. In other embodiments, one or more of the computer system 100, the payment gateway 110, and/or the credit server 120 can be implemented in a remote server and/or cloud-based software platform.

In variations of the embodiments, the computer system 100 can be connected and/or connectable to one or more of the external databases 130, 140, 150 the payment gateway 110, and/or the credit server 120 via one or more application programming interfaces (APIs) that permit the computer system 100 to: submit a request for data from the associated platform; receive or pull data from the associated platform; respond to a request for data from the associated platform; and transmit or push data to the associated platform. In some embodiments, the computer system 100 and associated platforms can execute REST APIs. In other embodiments, the computer system 100 can associated platforms can execute SOAP APIs. In still other embodiments, the computer system 100 and associated platforms can execute APIs of other types or formats.

As shown in FIGS. 1 and 3, embodiments of the computer system 100 can: access a credit transaction from the payment gateway 110 and/or the credit server 120. Generally, the credit transaction can include or be characterized by a set of underlying data from which an initial transaction profile and an initial risk profile is derived. In some embodiments, the initial transaction profile includes a set of data relating to the transaction, including information pertaining to the merchant, the purchaser, and/or the good/service being sold. In some embodiments, the initial risk profile is then generated in response to or as a function of the initial transaction data, and a borrowing rate is assigned to the transaction based at least in part upon the initial risk profile.

In variations of the embodiments, the computer system 100 can access an external server 130, 140, 150 including an external data set associated with the credit transaction. For example, an external data set can include data and/or information relating to the merchant, the purchaser, the product, the location and/or jurisdiction of the purchase/sale, the means or method of delivery or shipment, etcetera. In some embodiments, the computer system 100 can access one or more external servers 130, 140, 150, at least one of which includes publicly available data (e.g., sales tax rates at the point of purchase/sale). In other embodiments, the computer system 100 can access the one or more external servers 130, 140, 150 to retrieve, pull, scrape, and/or copy data or information that supports level three transactional data for the credit transaction.

As shown in FIGS. 1 and 3, in some embodiments the computer system 100 can: augment the initial transaction profile with the external data set to generate a secondary transaction profile and a secondary risk profile. As noted above, the initial transaction profile and the initial risk profile can be used by a credit issuing entity to set a rate of borrowing that is proportional to a level of risk associated with the transaction. Accordingly, the computer system 100 can access the external data sets as described herein, augment or supplement the initial transaction profile with the externally-obtained information or data, and then generate a secondary transaction profile that includes a more complete (e.g., level three transaction data) assessment of the risk associated with the transaction.

In variations of the embodiments, the computer system 100 augments the initial transaction profile by completing a set of informational or data fields that provide a full set of level three transaction data. In other embodiments, the computer system can import a data element from the external data set (e.g., a middle initial of the purchaser, a purchaser zip code, a merchant zip code, shipping origin and destinations, etc.). Generally, the external data imported by the computer system 100 will not be in a standardized or normalized format, for example state abbreviations, zip code plus four formats, and the like. Accordingly, the computer system 100 can further format, transform, translate, and/or normalize the data element the element into a compatible format suitable for reporting level three transaction data. In another embodiment, the computer system can automatically enter the formatted element into one of the initial purchaser dataset or the initial merchant dataset. For example, if the computer system 100 retrieves additional data relating to the merchant from a merchant database 140, then the computer system 100 can automatically import, enter, or complete remaining data fields within the initial merchant dataset such that all (or substantially all) of the required data fields contain accurate and properly formatted information. Similarly, if the computer system 100 retrieves additional data relating to the purchaser from a public database 130 (e.g., sales tax jurisdiction and rate), then the computer system 100 can automatically import, enter, or complete remaining data fields within the initial vendor dataset such that all (or substantially all) of the required data fields contain accurate and properly formatted information.

In other variations of the embodiments, the computer system 100 can transmit the secondary transaction profile to a credit server 120 associated with a credit provider. In some embodiments, the computer system 100 can directly transmit the secondary transaction profile to the credit server 120. Alternatively, the computer system 100 can transmit the secondary transaction profile to a payment gateway 110, which in turn can transmit the secondary transaction profile to the credit server 120 on its own behalf. In still other embodiments, the computer system 100 can be integrated with or a component part of the payment gateway 110 and configured as a transaction data module operating therein.

In other variations of the embodiments, the computer system 100 can receive a confirmation from the credit server 120 of the secondary transaction profile associated with the credit transaction. As noted above, a secondary risk profile can be computed in response to the secondary transaction profile, by one or more of the computer system 100, the payment gateway 110, or the credit server 120. Accordingly, in response to calculation and/or receipt of the secondary risk profile, the computer system 100 can receive from the credit server 120 a discounted interchange rate for the associated credit transaction. Alternatively, the credit server 120 can directly transmit the discounted interchange rate to the payment gateway 110, which as noted above can be integral with or embodied with the computer system 100.

### 4. Method

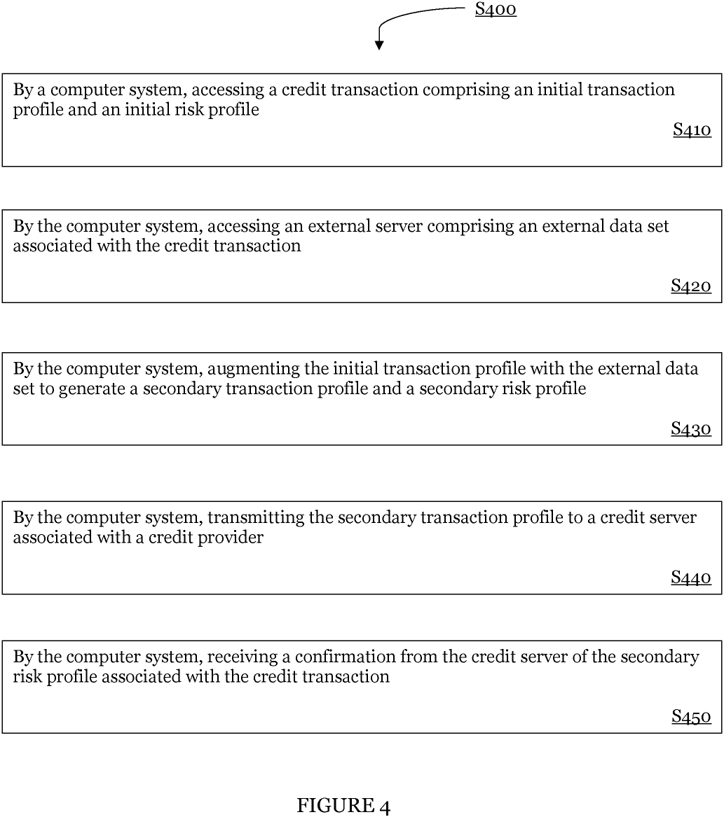

In some variations of the embodiments, the computer system 100 can be configured to implement or execute one or more techniques or methods. As shown in FIG. 4, a method S400 for augmenting or provisioning financial transaction data can include: accessing a credit transaction comprising an initial transaction profile and an initial risk profile in Block S410; accessing an external server comprising an external data set associated with the credit transaction in block S420; and augmenting the initial transaction profile with the external data set to generate a secondary transaction profile and a secondary risk profile in block S430. As shown in FIG. 4, the method S400 can also include: transmitting the secondary transaction profile to a credit server associated with a credit provider in block S440; and receiving a confirmation from the credit server of the secondary transaction profile associated with the credit transaction in block S450.

As noted above, the credit transaction can include or be characterized by a set of underlying data from which an initial transaction profile and an initial risk profile is derived. In some embodiments, the initial transaction profile includes a set of data relating to the transaction, including information pertaining to the merchant, the purchaser, and/or the good/service being sold. In some embodiments, the initial risk profile is then generated in response to or as a function of the initial transaction data, and a borrowing rate is assigned to the transaction based at least in part upon the initial risk profile.

In variations of the embodiments, an external data set can include data and/or information relating to the merchant, the purchaser, the product, the location and/or jurisdiction of the purchase/sale, the means or method of delivery or shipment, etcetera. In some embodiments, the computer system can execute block S420 of the method S400 by accessing one or more external servers, at least one of which includes publicly available data (e.g., sales tax rates at the point of purchase/sale). In other embodiments, the computer system can execute block S420 of the method S400 by accessing the one or more external servers to retrieve, pull, scrape, and/or copy data or information that supports level three transactional data for the credit transaction.

As shown in FIG. 4, in some embodiments the computer system can execute block S430 of the method S400 to augment the initial transaction profile with the external data set to generate a secondary transaction profile and a secondary risk profile. As noted above, the initial transaction profile and the initial risk profile can be used by a credit issuing entity to set a rate of borrowing that is proportional to a level of risk associated with the transaction. Accordingly, the computer system can access the external data sets in block S420, augment or supplement the initial transaction profile with the externally-obtained information or data in block S430, and then generate a secondary transaction profile that includes a more complete (e.g., level three transaction data) assessment of the risk associated with the transaction.

In variations of the embodiments, the computer system executes block S430 of the method S400 to augment the initial transaction profile by completing a set of informational or data fields that provide a full set of level three transaction data. As noted above, the computer system can import a data element from the external data set (e.g., a middle initial of the purchaser, a purchaser zip code, a merchant zip code, shipping origin and destinations, etc.). Additionally or alternatively, the computer system can execute block S430 of the method by formatting, transforming, translating, and/or normalizing the data element the element into a compatible format suitable for reporting level three transaction data. In another embodiment, the computer system can execute block S430 of the method S400 by automatically entering the formatted element into one of the initial purchaser dataset or the initial merchant dataset as noted above.

In other variations of the embodiments, the computer system can execute block S440 of the method S400 by transmitting the secondary transaction profile to a credit server associated with a credit provider. In some variations of the embodiments, the computer system can directly transmit the secondary transaction profile to the credit server. Alternatively, the computer system can transmit the secondary transaction profile to a payment gateway, which in turn can transmit the secondary transaction profile to the credit server on its own behalf. In still other embodiments, the computer system can be integrated with or a component part of the payment gateway and configured as a transaction data module operating therein.

As shown in FIG. 4, in other variations of the embodiments, the computer system execute block S450 of the method S400 by receiving a confirmation from the credit server of the secondary transaction profile associated with the credit transaction. As noted above, a secondary risk profile can be computed in response to the secondary transaction profile, by one or more of the computer system, the payment gateway, or the credit server. Accordingly, in another variation of the embodiments, in response to calculation and/or receipt of the secondary risk profile, the computer system can receive from the credit server a discounted interchange rate for the associated credit transaction. Alternatively, the credit server can directly transmit the discounted interchange rate to the payment gateway, which as noted above can be integral with or embodied with the computer system.

Generally, the computer system can execute blocks of the method S400 in an operating environment of the type described above. For example, in executing blocks of the method S400, the computer system can communicate with a payment gateway, a credit server associated with a credit transaction (e.g., a credit card transaction), and one or more external databases including for example a public database, a merchant database, and a purchaser database. As described in detail below, in some embodiments two or more of the external databases can be assembled, combined, and/or managed as a single database and integrated with the computer system.

In variations of the embodiments, the computer system can execute blocks of the method S400 via one or more APIs that permit the computer system to: submit a request for data from the associated platform; receive or pull data from the associated platform; respond to a request for data from the associated platform; and transmit or push data to the associated platform. In some embodiments, the computer system and associated platforms can execute REST APIs. In other embodiments, the computer system and/or associated platforms can execute SOAP APIs. In still other embodiments, the computer system and associated platforms can execute APIs of other types or formats.

### 5. Example Implementations

As described above, the computer system 100 can execute blocks of the method S400 to automatically access, translate, transform, and update transactional data (e.g., to include level three transactional data) to a credit server 120 such that a user associated with a payment gateway 110 can benefit from discounted interchange rates in financing credit-based transactions.

It will be readily understood that the components of various embodiments of the present invention, as generally described and illustrated in the figures herein, can be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification can be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics can be combined in any suitable manner in one or more embodiments.

It should be noted that reference throughout this specification to features, advantages, or similar language does not imply that all of the features and advantages that can be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification can, but do not necessarily, refer to the same embodiment.

Furthermore, the described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention.

One having ordinary skill in the art will readily understand that the invention as discussed above can be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

What is claimed is:

1. A computer-implemented method for the automatic provision of transactional data comprising:
by a computer system, accessing a credit transaction comprising an initial transaction profile and an initial risk profile;
by the computer system, accessing an external server comprising an external data set associated with the credit transaction;
by the computer system, augmenting the initial transaction profile with the external data set to generate a secondary transaction profile and a secondary risk profile;
by the computer system, transmitting the secondary transaction profile to a credit server associated with a credit provider; and
by the computer system, receiving a confirmation from the credit server of the secondary transaction profile associated with the credit transaction.

2. The method of claim 1, further comprising:
by the computer system, accessing a second external server comprising a second external data set associated with the credit transaction, wherein the second external server comprises a database comprising publicly available data.

3. The method of claim 1, wherein:
the initial transaction profile comprises an initial purchaser dataset and an initial merchant dataset; and
the initial risk profile is computed in response to the initial transaction profile.

4. The method of claim 3, wherein augmenting the initial transaction profile comprises:
by the computer system, importing an element from the external data set;
by the computer system, formatting the element into a compatible format;
by the computer system, automatically entering the formatted element into one of the initial purchaser dataset or the initial merchant dataset.

5. The method of claim 4, wherein the formatted element comprises level three transactional data.

6. The method of claim 5, wherein the secondary risk profile is computed in response to the secondary transaction profile.

7. The method of claim 6, wherein receiving a confirmation from the credit server of the secondary transaction profile associated with the credit transaction comprises:
receiving, from the credit server, a discounted interchange rate associated with the credit transaction.

8. A computer system for the automatic provision of transactional data comprising:
at least one processor; and
memory comprising a set of instructions for the automatic provision of transactional data, wherein the set of instructions, with the at least one processor, is configured to cause the computer system to:
access a credit transaction comprising an initial transaction profile and an initial risk profile;
access an external server comprising an external data set associated with the credit transaction;
augment the initial transaction profile with the external data set to generate a secondary transaction profile and a secondary risk profile;
transmit the secondary transaction profile to a credit server associated with a credit provider; and
receive a confirmation from the credit server of the secondary transaction profile associated with the credit transaction.

9. The computer system of claim 8, wherein the set of instructions, together with the at least one processor, are further configured to:
access a second external server comprising a second external data set associated with the credit transaction, wherein the second external server comprises a database comprising publicly available data.

10. The computer system of claim 8, wherein:
the initial transaction profile comprises an initial purchaser dataset and an initial merchant dataset; and
the initial risk profile is computed in response to the initial transaction profile.

11. The computer system of claim 10, wherein the set of instructions and the at least one processor are further configured to:
import an element from the external data set;
format the element into a compatible format;
automatically enter the formatted element into one of the initial purchaser dataset or the initial merchant dataset.

12. The computer system of claim 11, wherein the formatted element comprises level three transactional data.

13. The computer system of claim 12, wherein the secondary transaction profile is computed in response to the secondary transaction profile.

14. The computer system of claim 13, wherein the set of instructions and at least one processor are further configured to:
receive, from the credit server, a discounted interchange rate associated with the credit transaction.

15. A computer program embodied on a non-transitory computer readable medium, the computer program when executed is configured to cause at least one processor to:
access a credit transaction comprising an initial transaction profile and an initial risk profile;
access an external server comprising an external data set associated with the credit transaction;
augment the initial transaction profile with the external data set to generate a secondary transaction profile and a secondary risk profile;
transmit the secondary transaction profile to a credit server associated with a credit provider; and
receive a confirmation from the credit server of the secondary transaction profile associated with the credit transaction.

16. The computer program product of claim 15, wherein the computer program product is further configured to cause at least one processor to:
access a second external server comprising a second external data set associated with the credit transaction, wherein the second external server comprises a database comprising publicly available data.

17. The computer program product of claim 15, wherein:
the initial transaction profile comprises an initial purchaser dataset and an initial merchant dataset; and
the initial risk profile is computed in response to the initial transaction profile.

18. The method of claim 17, wherein the computer program product is further configured to cause the at least one processor to:
import an element from the external data set;
format the element into a compatible format;
automatically enter the formatted element into one of the initial purchaser dataset or the initial merchant dataset.

19. The computer program product of claim 18, wherein:
the formatted element comprises level three transactional data; and
the secondary risk profile is computed in response to the secondary transaction profile.

20. The computer program product of claim 19, wherein the computer program product is further configured to cause at least one processor to:
receive, from the credit server, a discounted interchange rate associated with the credit transaction.
